(19) United States
(12) Patent Application Publication
(10) Pub. No.: US 2026/0350750 A1
(43) Pub. Date: Nov. 5, 2026

(54) SCENE BRIGHTNESS ADAPTATION FOR RENDERING OF CAPTURED IMAGE/VIDEO DATA

(71) Applicant: APPLE INC., Cupertino, CA (US)

(72) Inventors: Qing SONG, Santa Clara, CA (US); Arjun Chauhan, Santa Clara, CA (US); Jin Wook CHANG, San Jose, CA (US); Xiaohua YANG, San Jose, CA (US); Xin WANG, Cupertino, CA (US)

(21) Appl. No.: 19/198,998

(22) Filed: May 5, 2025

Related U.S. Application Data
(60) Provisional application No. 63/657,895, filed on Jun. 9, 2024.

(51) Int. Cl. G06T 5/50; G06T 5/40; G06T 5/92; G06T 7/00; G06T 11/10; G06T 11/60

(52) U.S. Cl. CPC G06T 5/50; G06T 5/40; G06T 5/92; G06T 7/0002; G06T 11/10; G06T 11/60; G06T 2207/20221; G06T 2207/30168; G06T 2210/32

(57) ABSTRACT

Embodiments of the present disclosure provide an image capturing system that generates images and/or video that contain pixel data representing the image's/video's content and metadata representing a measurement of scene brightness at the time of capture. Embodiments of the present disclosure further provide an image processing system that alter the image's/video's pixel data according to the measured scene brightness at the time of rendering. In this manner, display of images and/or videos that have different scene brightnesses at the time of capture may be displayed in a manner that retains differences among these brightnesses.

### CLAIM FOR PRIORITY

This application claims the benefit of priority of U.S. Provisional Application No. 63/657,895, filed on Jun. 9, 2024, the disclosure of which is incorporated by reference herein.

### BACKGROUND

The present disclosure is directed to techniques for rendering image/video content that is captured under varying lighting characteristics in a manner that preserves differences in brightness at the time of capture.

Consumer display systems are tasked to render image/video information from a variety of sources and representing a variety of types of image content. For example, professionally-produced video, such as professional-grade movies and television programming, are familiar rendering applications. Professionally-produced videos typically are captured in tightly-controlled lighting conditions, they are deliberately framed, and they are professionally graded afterwards by colorists in dim studios to match the director's aesthetic goals. Multiple versions often are created, which are graded for different display types. For example, a first version may be created for 100-nit SDR displays, a second version may be created for 1000-nit HDR displays, and a further version may be created for 4000-nit HDR displays. Content services stream versions to the users that are selected according to their displays'characteristics.

It also is familiar to render, at consumer display systems, video captured by ordinary consumers at mobile devices. Mobile captures often are captured in imperfect conditions, and they have minimal (or no) post-capture editing capability. While captures may be graded manually, typically only one version of the captured image is generated by a pre-designed algorithm. This version will be distributed to various displays and platforms. Post-capture rendering algorithms may attempt to adapt image playback to a given display and viewing conditions but they are limited to the information content in the asset's file. For example, one post-capture rendering algorithm may attempt to adapt playback to the pixel distributions of each frame. But the pixel data itself may not adequately represent scene brightness and, consequently, the rendered pixels do not always accurately reflect the capturing conditions.

### BRIEF DESCRIPTION OF THE DRAWINGS

FIG. 1 is a block diagram of a video processing system according to an aspect of the present disclosure.

FIG. 2 illustrates a rendering control system according to an embodiment of the present disclosure.

FIG. 3(a) and 3(b) illustrate exemplary images that may be processed according to embodiments of the present disclosure.

FIG. 4 is a graph comparing cumulative distribution functions of pixel values of the images of FIG. 3(a) and 3(b) that may be generated by exemplary image processing applications.

FIG. 5(a) and 5(b) illustrates exemplary adjustment functions that may be generated for the images of FIG. 3(a) and 3(b) according to an embodiment of the present disclosure.

FIG. 6 illustrates an exemplary composite image that may be processed according to embodiments of the present disclosure.

FIG. 7 illustrates a rendering control system according to another embodiment of the present disclosure.

FIG. 8 illustrates an image processing system according to an embodiment of the present disclosure.

### DETAILED DESCRIPTION

Embodiments of the present disclosure provide an image capturing system that generates images and/or video that contain pixel data representing the image's/video's content and metadata representing a measurement of scene brightness at the time of capture. Embodiments of the present disclosure further provide an image processing system that alters the image's/video's pixel data according to the scene brightness metadata. In this manner, display of images and/or videos that have different scene brightnesses at the time of capture may be displayed in a manner that retains differences among these brightnesses.

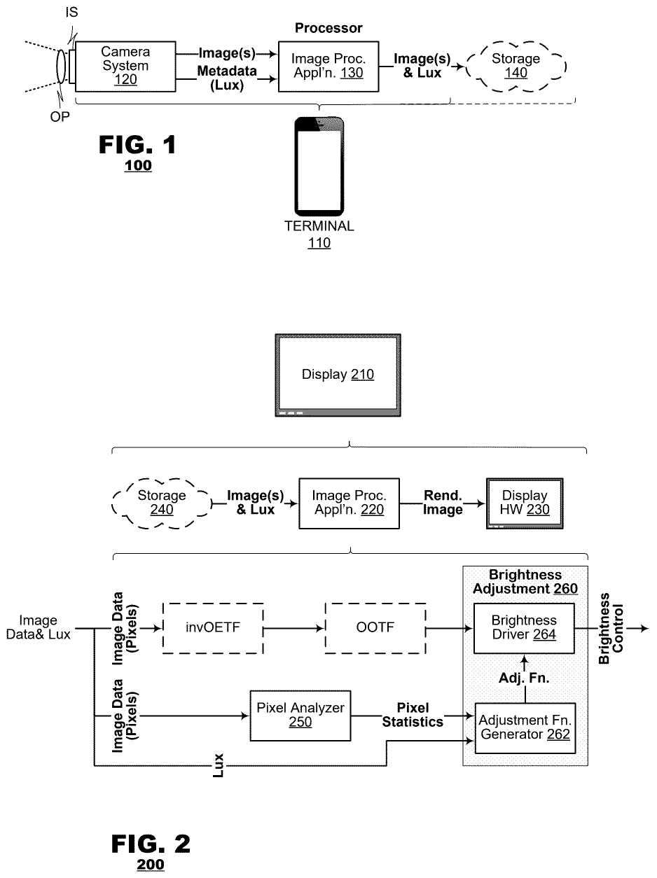

FIG. 1 is a block diagram of a video processing system 100 according to an aspect of the present disclosure. The system 100 finds application with a variety of camera-enabled consumer electronics products, such as smartphones 110, tablet computers, digital cameras, digital video recorders, and the like. The system 100 may include a camera system 120, one or more image processing applications 130, and, optionally, a storage system 140. The camera system 120 may capture image information from a local environment and generate a “raw” image stream therefrom. The processing application(s) 130 represent processors and program instructions that execute on the processors to generate formal media assets (e.g., image files, video files) from the raw image stream. The storage system 140 may store the assets; it be an on-device storage system or it may be a network-based storage system to which the device 110 sends the asset files.

The camera system 120 typically includes one or more imaging devices, such as CMOS—or CCD-based image sensors IS. Each image sensor typically generates image information from an array of pixel circuits provided on a face of the image sensor. The image sensor IS typically is integrated with an optical system OP comprising one or more lenses, filters, and the like. The camera system 120 also may contain a processing system that performs various operations on image information generated by the image sensor IS, such as color interpolation, color correction, and the like. The camera system 120 typically operates as an input device for the device 110 and it supplies the stream of raw image information to other processor(s) on the device, which may execute operating system and/or application functions that consume the image information from the camera system 120. Typically the camera system 120 generates the image information in frames at a respective frame rate. The number of pixels and the output frame rate of the camera system may vary across different implementations. For example, common image sensors may have 48, 24, or 12 megapixels and generate images at a rate of 120 frames per second or more. Moreover, many devices 110 have multiple image sensors, which generate image streams based on image processing that merges image information from the multiple sensors.

In an embodiment, the camera system 120 may measure brightness of a scene being imaged and provides a representation (shown as “lux”) of the measured brightness in metadata that is provided with images of the stream. Instances of measured brightness may be provided individually for each frame output from the camera system 120 or may be provided on a periodic basis, with each instance of brightness metadata representing measured brightness over a respective range of frames. The brightness values may be represented in different ways. In one embodiment, brightness may be represented as a “scene lux” value representing the average brightness of the scene represented in units of lux. In another embodiment, brightness may be represented as a “clipping point lux” value, representing the max brightness of the scene represented in units of lux. In other embodiments, the metadata may carry representations of both scene lux and clipping point lux.

The image processing application 130 represents one or more processing applications or operating system sub-systems that process image data output from the camera system 120. In its simplest form, the image processing application 130 may be a camera application that generates an image (or video) file in response to a user-entered capture command. In other embodiments, the image processing application 130 may include editing tools that allow users to perform composition operations on captured images or video, such as by cropping and/or rotating an image, applying filters to captured images, altering image brightness, and retouching image content. Further, other image processing applications 130 allow users to edit image content by, for example, adding synthetic content or content from other image sources to image data from the camera system 120. The principles of the present disclosure operate cooperatively with all such applications.

In an embodiment, the image processing application 130 may provide metadata with images or video that it outputs to storage representing measured brightness at the time the image or video was captured by the image system 120. In FIG. 1, the metadata again is represented as lux.

As discussed, the storage system 140 may be provided on the device 110 itself or it may be provided as a separate storage system provided in communication with the device 110 via a communication network (not shown). The storage system 140 may store images and/or video output by the image processing application 130 along with the brightness metadata representing measured brightness associated with those images and/or video.

FIG. 2 illustrates a rendering control system 200 according to an embodiment of the present disclosure. The rendering control system 200 finds application with a variety of consumer display devices 210 such as monitors, smart televisions, and billboard-style display devices. The rendering control system 200 may include an image processing application 220 and a display hardware system 230. The rendering control system 200 may receive images and brightness metadata from a storage system 240 such as an on-device memory system or network-accessible storage system.

The image processing application 220 may generate control signals for the display hardware 230. As relevant to the present disclosure, the image processing application 220 may generate a brightness control signal that it supplies to the display hardware 230 to control illumination element(s) within the display hardware 230. The brightness control signal may control a brightness level of the display. For example, the brightness control signal may be generated as a codeword that represents a brightness level to be used within the display.

The image processing application 220 may include a pixel analysis subsystem 250 and a brightness adjustment unit 260. The pixel analysis subsystem 250 may have an input for image data to be displayed, typically, pixel data of each frame to be displayed. The pixel analysis subsystem 250 may generate pixel statistics therefrom, which may be represented as one or more of histograms of a frame's pixel values, pixel percentiles, average and maximum pixel values of the frame, and the like. The pixel statistics may be output to the brightness adjustment unit 260.

The brightness adjustment unit 260 may include an adjustment function generator 262 and a brightness driver 264. The adjustment function generator 262, as its name implies, may generate an adjustment function to the brightness driver 264. The brightness driver 264 may generate the brightness control signal that is output to the display hardware 230.

The adjustment function generator 262 may accept frame pixel statistics from the pixel analyzer 250 and the frame's brightness value. It may generate a brightness adjustment value in response to these inputs. By factoring the frame's brightness value into a control of display brightness, the display hardware 230 can be made to render image data at a brightness level that corresponds to the brightness of the image when it was captured.

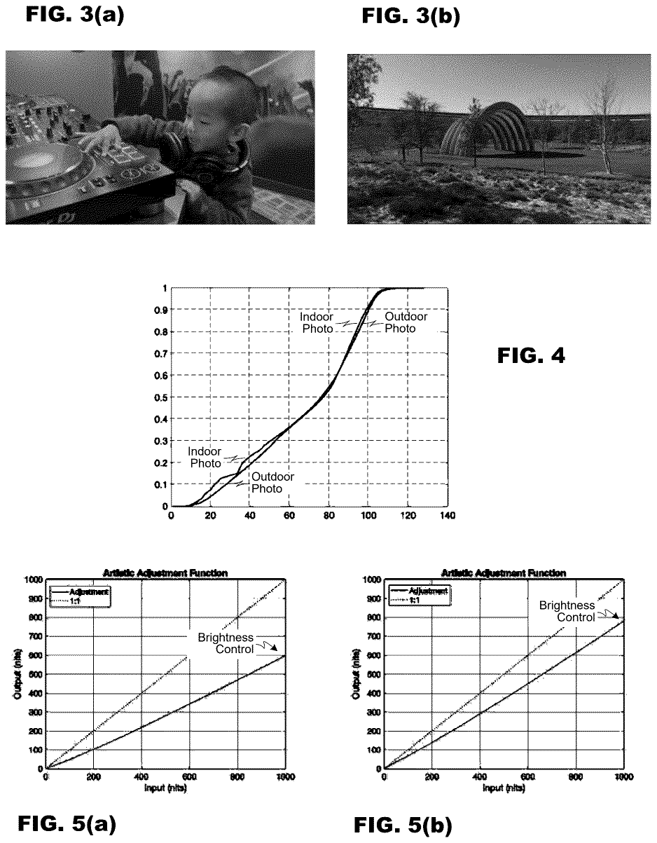

FIGS. 3-5 illustrate application of the brightness controls applied by a brightness adjustment unit 260 in the context of two exemplary images. A first image, shown in FIG. 3(a), illustrates an image captured in an indoor environment where artificial illumination is present. A second image, shown in FIG. 3(b), illustrates an image captured in an outdoor environment on a sunny day. The overall brightness of the FIG. 3(b) image is far greater than the overall brightness of the FIG. 3(a) image.

FIG. 4 illustrates cumulative distribution functions of pixel values of the two images that might be generated from processing of a camera system and an image processing application of a conventional consumer electronics product. As shown, conventional image processing techniques cause distributions of pixel values to be similar to each other notwithstanding the strong differences in scene brightness at the time the images were captured.

FIG. 5 illustrates exemplary adjustment functions for the images of FIG. 3. In each case, relative differences in the scene lux among the images are factored into the brightness control signal. For the indoor image illustrated in FIG. 3(a), it may be assumed that the scene lux is 400 lux. An exemplary adjustment function for the image is plotted in FIG. 5(a). For a 1000-nit-peak display, the max brightness value (1000 nits) may be mapped to about 600 nits. Other brightness levels may be mapped as defined by the adjustment function. While the example of FIG. 5(a) illustrates a linear mapping function for illustration purposes, in practice, a non-linear mapping function likely may be used.

Without the brightness controls of the present disclosure, the image of FIG. 3(a) might otherwise be displayed at the display hardware's maximum brightness, which may introduce perceptual distortions. In the example of FIG. 3(a), interior walls, which should be considered background elements of the image, might be displayed at such a brightness that they appear to be “glowing” behind the subject of interest. The brightness controls of FIG. 2, however, may constrain the maximum brightness of image elements—again, the maximum brightness is shown as 600 nits for a 1000 nit display in the example of FIG. 5—which may reduce prevalence of such distortions.

For the outdoor image illustrated in FIG. 3(b), it may be assumed that the scene lux is 56,000 lux. An exemplary adjustment function for the image is plotted in FIG. 5(b). For a 1000-nit-peak display, the max brightness value (1000 nits) may be mapped to about 800 nits. Other brightness levels may be mapped as defined by the adjustment function. While the example of FIG. 5(b) also illustrates a linear mapping function for illustration purposes, in practice, a non-linear mapping function may be used.

When an image is rendered using the brightness controls of FIG. 2, it is expected that the resulting video display will shows higher brightness and better contrast than the indoor scene FIG. 3(a), which will better preserve the captured feeling of both images and improving scene variations.

In practice, adjustment functions can be tailored for different display types, using the same inputs. For example, another adjustment function may be developed for 100-nit-peak SDR displays, and a further adjustment function may be developed for 1000-nit-peak HDR displays. Therefore, the playback of the video can be adapted to different displays by using the same metadata.

In one application, an adjustment function may be defined as a spline curve having the form:

yᵢ=c_{i,0}+c_{i,1}*avg+c_{i,2}*sl+c_{i,3}*avg²+c_{i,4}*avg*sl+c_{i,5}*sl²+. . .,

where sl represents the frame's brightness value and avg represents the average pixel values across the frame. Coefficient values c_{i,0}, c_{i,1}, c_{i,2}, c_{i,3}, c_{i,4}, c_{i,5}, etc. may be developed to generate a desired adjustment function for a given lux and a given set of pixel statistics.

Returning to FIG. 2, the rendering control system 200 is illustrated in an application where a display device 210 processes image data according to inverse opto-electrical transfer functions (OETF) and opto-optical transfer function (OOTF). Generally, an OETF represents a processing system that applies a transfer function convert an image represented as scene light values to pixel values; the inverse OETF inverts that process and supplies scene light values to the OOTF. An OOTF represents a processing system that applies a transfer function to convert scene light values to a displayed light value. Thus, the output of the OOTF represents pixel values in nits. Operation of the invOETF and OOTF processes are standardized, for example, in ITU-R recommendation BT.2100. The brightness driver 264 may convert OOTF output pixel values to driver pixel values, which also are expressed in nits, by direct application of the adjustment function from the adjustment function generator 262.

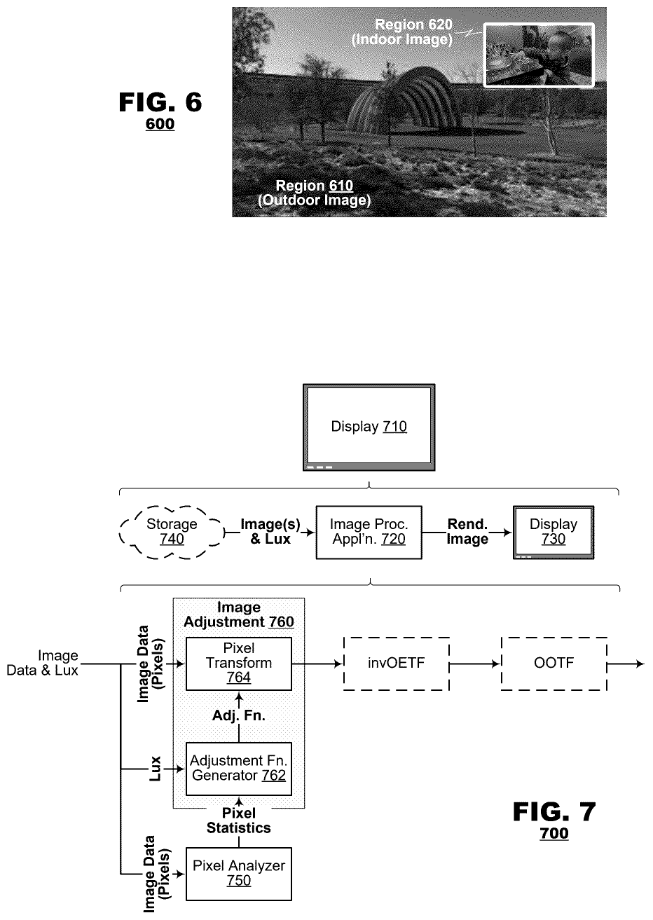

Many rendering applications call for simultaneous display of multiple images. In such instances, an image processing application 220 may process image data of two or more images and perform compositional operations to generate a composite image from those source images. One example is illustrated in FIG. 6, where the indoor image of FIG. 3(a) is shown superimposed over the outdoor image of FIG. 3(b) as a “picture-in-picture” inset.

The principles of the present disclosure find application with composite images. In one embodiment, separate instances of the rendering control system 200 may be invoked for each source image, which generate respective adjustment functions for the spatial regions occupied by the respective images. Thus, adjustment functions may be generated for the regions 610, 620 associated, respectively, with the outdoor image and the indoor image in the example of FIG. 6. The adjustment functions may be scaled relative to each other to provide an effect that resembles the image's relative difference in brightness.

Note that it is not required to scale the adjustment functions quantitatively according to differences in the images'brightnesses. Earlier, with reference to the examples of FIG. 3(a) & 3(b), the outdoor image was described as having a brightness of 56,000 and the indoor scene as having a brightness of 400 lux. It is not necessary to scale brightness of the indoor image so that it is 1/140^{th} as bright as the outdoor image. It may be sufficient simply to scale brightness so that its overall brightness is lower than the brightness of the outdoor image, for example, setting it to 80% of the brightness of the outdoor image. The brightness proportions of different regions of composite images may be tailored to suit individual application needs.

FIG. 7 illustrates a rendering control system 700 according to an embodiment of the present disclosure. The rendering control system 700 also finds application with a variety of consumer display devices 710 such as monitors, smart televisions, and billboard-style display devices. The rendering control system 700 may include an image processing application 720 and a display hardware system 730. The rendering control system 700 may receive images and brightness metadata from a storage system 740 such as an on-device memory system or network-accessible storage system.

The image processing application 720 may generate control signals for the display hardware 730. As relevant to the FIG. 7 embodiment, the image processing application 720 may convert pixel values in an image (or video) domain to pixel values for display by the display hardware 730.

The image processing application 720 may include a pixel analysis subsystem 750 and an image adjustment unit 760. The pixel analysis subsystem 750 may have an input for image data to be displayed, typically, pixel data of each frame to be displayed. The pixel analysis subsystem 750 may generate pixel statistics therefrom, which may be represented as one or more of histograms of a frame's pixel values, pixel percentiles, average and maximum pixel values of the frame, and the like. The pixel statistics may be output to the image adjustment unit 760.

The image adjustment unit 760 may include an adjustment function generator 762 and a pixel transform unit 764. The adjustment function generator 762, as its name implies, may generate an adjustment function to the pixel transform unit 764. The pixel transform unit 764 may convert pixel values form the source image domain to a pixel domain with constrained brightness. The transformed pixels may be output to a pixel processing pipeline within the display device 710. In the application illustrated in FIG. 7, the processing pipeline includes an inverse OETF unit and an OOTF unit. Pixel values output from the OOTF may be output to the display hardware 730.

The adjustment function generator 762 may accept frame pixel statistics from the pixel analyzer 750 and the frame's brightness value. It may generate an image adjustment value in response to these inputs. By factoring the frame's brightness value into a pixel transform process, the display hardware 730 can be made to render image data at a brightness level that corresponds to the brightness of the image when it was captured.

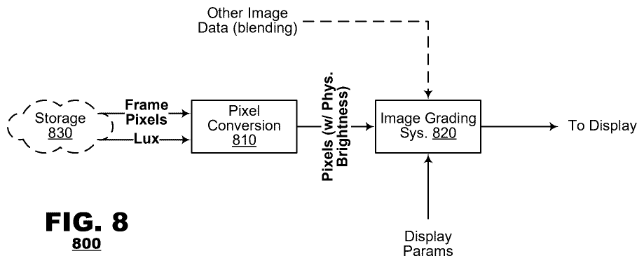

FIG. 8 illustrates an image processing system 800 according to another embodiment of the present disclosure. The system 800 may include a pixel converter 810 and an image grading system 820. The system 800 may receive a source image and brightness metadata from a storage system 640 such as an on-device memory system or network-accessible storage system. The pixel conversion system 810 may process pixel data of the image according to the brightness metadata to generate pixel values representing a physical domain of the source image. In other words, where conventional image processing applications strip out brightness differences between images captured under different brightness scenarios (e.g., FIG. 4), the pixel converter 810 may recover such differences by scaling pixel values of images according to their respective brightness metadata. In this regard, the pixel values output by the pixel converter 810 represent values in a model of the physical domain when the image was captured.

The image grading system 820 may perform grading operations on the converted image as may be desired for display applications for which the image will be rendered. Typically, such operations involve grading the image according to parameters of a target display on which the image will be rendered. Grading operations also may involve compositional processes such as applying desired color palettes to the image, applying presentation filters to the image, and/or blending the image content with other content elements such as virtual objects. Graded image content generated by the image grading system may be output to a display or stored for later consumption as may be desired.

The foregoing discussion has described operation of the aspects of the present disclosure in the context of processing systems used within consumer electronic devices. These processing systems may be embodied in various forms. The processing systems, for example, can be embodied in integrated circuits, such as application specific integrated circuits, field programmable gate arrays, and/or digital signal processors. Alternatively, they can be embodied in computer programs that execute on processors within the consumer electronic devices. Such computer programs typically are stored in physical storage media such as electronic-, magnetic-, and/or optically-based storage devices, where they are read to a processor and executed. And, of course, these processing systems may be provided as hybrid systems that distribute functionality across dedicated hardware components and programmed general-purpose processors, as desired.

Several embodiments of the present invention are specifically illustrated and described herein. However, it will be appreciated that modifications and variations of the present invention are covered by the above teachings and within the purview of the appended claims without departing from the spirit and intended scope of the invention.

1. An image capture system, comprising:
a camera system that captures image data of a local environment and a measurement of brightness of the local environment at a time of capture, and
a processor that generates an image file having pixels representing the image data at the time of capture, the pixel values having value distributions mapped according to predetermined maximum values associated with the image file, the image file also containing metadata representing the measurement of brightness of the local environment at a time of capture.

2. The system of claim 1, wherein the measurement of brightness is a scene lux parameter representing average brightness of the captured image data.

3. The system of claim 1, wherein the measurement of brightness is a clipping point lux parameter representing maximum brightness of the captured image data.

4. An image processing method, comprising, responsive to image information having pixel values of an image and metadata representing measured brightness of the image at a time of image capture:
generating an adjustment function based on statistics of the pixel values and the measured brightness,
applying the adjustment function to the pixel values, and
outputting adjusted pixel values to a display.

5. The image processing method of claim 4, wherein the adjustment function constrains maximum brightness of the adjusted pixel values.

6. The image processing method of claim 4, wherein the applying scales pixel values output by opto-optical transfer function process by the adjustment function.

7. The image processing method of claim 4, wherein the applying scales source pixel values of the image before inputting the scaled pixel values to an opto-optical transfer function process.

8. The image processing method of claim 4, wherein the adjustment function is a non-linear transform curve.

9. The image processing method of claim 4, wherein the adjustment function is a spline-based transform curve.

10. The image processing method of claim 4, wherein the adjustment function is determined in part by characteristics of the display.

11. The image processing method of claim 4, wherein the statistics are represented by a histogram of pixel values of the image.

12. The image processing method of claim 4, wherein the statistics are represented by an average and maximum pixel values of the image.

13. The image processing method of claim 4, wherein the statistics are represented by pixel percentiles of pixel values of the image.

14. The image processing method of claim 4, wherein, for a rendering application involving a composite of two images:
the generating is performed independently on each image, generating respective adjustment functions based on statistics of the respective image's pixel values and measured brightness,
the respective adjustment functions are merged into a composite adjustment function with each adjustment function scaled in association with its respective image's brightness, and
the applying applies the composite adjustment function to the pixel values of the composite image.

15. A method comprising:
converting pixel values of a source image from a domain of the source image to a physical domain according to metadata, stored with the source image, representing a brightness of the source image measured at a time of capture of the source image,
performing a grading operation on the physical-domain pixel values.

16. The method of claim 15, wherein the grading operation includes applying a color palette to the physical-domain pixel values.

17. The method of claim 15, wherein the grading operation includes adjusting the physical-domain pixel values according to parameters of a display to render the image.

18. The method of claim 15, wherein the grading operation includes applying a filter to the physical-domain pixel values.

19. The method of claim 15, wherein the grading operation includes blending a content item with the physical-domain representation of the source image.
